(19) United States
(12) Patent Application Publication
(10) Pub. No.: US 2021/0292494 A1
(43) Pub. Date: Sep. 23, 2021

(54) ENVIRONMENT-FRIENDLY SHEET AND PREPARATION METHOD THEREOF

(71) Applicant: JIANGSU LANGYUE NEW MATERIALS TECHNOLOGY CO., LTD., Jiangsu (CN)

(72) Inventor: Guoping LI, Jiangsu (CN)

(73) Assignee: JIANGSU LANGYUE NEW MATERIALS TECHNOLOGY CO., LTD., Jiangsu (CN)

(21) Appl. No.: 17/002,791

(22) Filed: Aug. 26, 2020

Related U.S. Application Data
(63) Continuation of application No. PCT/CN2020/080148, filed on Mar. 19, 2020.

(51) Int. Cl. C08J 5/18; C08K 3/22; C08K 7/06; C08J 5/04; C08L 29/04; C08K 7/22; C08K 3/016

(52) U.S. Cl. CPC C08J 5/18; C08K 3/22; C08K 7/06; C08K 2003/2227; C08L 29/04; C08K 7/22; C08K 3/016; C08J 5/042

(57) ABSTRACT

The present invention relates to an environment-friendly sheet and a preparation method thereof, and relates to the technical field of sheets and manufacturing thereof. The environment-friendly sheet is mainly prepared from the following components in parts by weight: 20-50 parts of polyvinyl alcohol; 40-60 parts of water; 0.1-5 parts of a waterproof agent; 1-20 parts of fiber; 1-7 parts of porous hollow microspheres; 0.1-30 parts of mineral powder; 0.1-2 parts of an antibacterial agent; 0-2 parts of a humectant; 0-2 parts of a pigment; 0-10 parts of a flame retardant; and 0-2 parts of a thickener.

### CROSS-REFERENCE TO RELATED APPLICATION

This application is a continuation of international PCT application serial no. PCT/CN2020/080148 filed on Mar. 19, 2020. The entirety of the above-mentioned patent application is incorporated herein by reference and made a part of this specification.

### BACKGROUND OF THE INVENTION

### 1. Technical Field

The present invention relates to the technical field of sheets, in particular to an environment-friendly sheet and a preparation method thereof.

### 2. Background Art

In construction, a silence pad is usually laid on the ground just below the flooring to provide functions such as noise reduction, heat preservation and moisture resistance, in which the purpose of noise reduction is achieved by reducing or interrupting the sound transmission effect of solid. With the improvement of living standards, people are paying more attention to the living environment and quality of life, and in particular, the environment-friendly silence pad has become the first choice.

Chinese Patent Application Publication No. CN108915210A discloses a floor with a silence pad and a production process thereof. The floor includes a flooring layer, a bonding layer and the silence pad from top to bottom, wherein the silence pad may be a PE foam film. The production process of the flooring includes the following steps of: firstly, applying the bonding layer to the silence pad by curtain coating to provide the silence pad with a layer of hot melt film; and bonding the silence pad with the hot melt film to the floor by utilizing the temperature of the production line during manufacturing of the flooring layer. The flooring disclosed in the above patent is easy to operate and low in production cost.

The above technical solution in prior art has the following deficiency: the PE foam film has poor mechanical properties, such as low tensile strength and proneness to deformation, so that the PE foam film has a short service life when being used as a silence pad.

### SUMMARY OF THE INVENTION

In a first aspect, an environment-friendly sheet is provided which has the advantages of high tensile strength and prolonged service life: an environment-friendly sheet, mainly prepared from the following components in parts by weight: 20-50 parts of polyvinyl alcohol; 40-60 parts of water; 0.1-5 parts of a waterproof agent; 1-20 parts of fiber; 1-7 parts of porous hollow microspheres; 0.1-30 parts of mineral powder; 0.1-2 parts of an antibacterial agent; 0-2 parts of a humectant; 0-2 parts of a pigment; 0-10 parts of a flame retardant; and 0-2 parts of a thickener.

By adopting the above technical solution, polyvinyl alcohol has good filming, bonding and emulsifying properties as well as excellent grease resistance and solvent resistance, and is degradable; the waterproof agent can enhance the waterproof performance of the sheet, so that the possibility of moisture or water permeation of the sheet is reduced; fiber is excellent in extensibility and light in self-weight, so that the load bearing and stretchability of the sheet can be increased while the weight of the sheet can be reduced; porous hollow microspheres have excellent physical and chemical properties such as low density and high thermodynamic stability, so that the heat insulation and sound absorption performance of the sheet can be improved; mineral powder can reduce the porosity of the sheet in the forming process so as to improve the crack resistance and corrosion resistance of the sheet; the antibacterial agent can improve the corrosion resistance of the sheet; the humectant can keep the sheet to have a certain water content, so that the possibility of warping or cracking of the sheet is reduced; the pigment can improve the physical properties, water resistance and wear resistance of the sheet; the flame retardant can improve the flame retardance of the sheet and reduce the possibility of accidents caused by inflammability of the sheet; and the thickener can improve the solution stability in the preparation process of the sheet, adjust the solution viscosity, and increase the viscosity of dispersion-related components to facilitate dispersion of the related components. Compared with the prior art, the sheet prepared with this technical solution has good tensile and anti-cracking properties, and also has good performance in sound insulation and heat insulation.

In a preferred embodiment of the present invention, the environment-friendly sheet is mainly prepared from the following components in parts by weight: 20-50 parts of polyvinyl alcohol; 40-60 parts of water; 1-5 parts of an aqueous waterproof agent; 1-20 parts of fiber; 1-7 parts of porous hollow microspheres; 0.1-30 parts of mineral powder; 0.1-2 parts of an antibacterial agent; 0-2 parts of a humectant; 0-2 parts of a pigment; 0-10 parts of a flame retardant; and 0-2 parts of a thickener.

By adopting the above technical solution, the aqueous waterproof agent improves the waterproof performance of the sheet while causing low harm and little influence on the environment.

In a preferred embodiment of the present invention, the environment-friendly sheet is mainly prepared from the following components in parts by weight: 20-50 parts of polyvinyl alcohol; 40-60 parts of water; 0.1-2 parts of a non-aqueous waterproof agent; 1-20 parts of fiber; 1-7 parts of porous hollow microspheres; 0.1-30 parts of mineral powder; 0.1-2 parts of an antibacterial agent; 0-2 parts of a humectant; 0-2 parts of a pigment; 0-10 parts of a flame retardant; and 0-2 parts of a thickener; the non-aqueous waterproof agent being selected from one or more of the group consisting of polyurethane, a fatty acid-based waterproof agent and a stearic acid-based waterproof agent.

By adopting the above technical solution, the non-aqueous waterproof agent can penetrate deeply into an object so as to effectively improve the waterproof performance of the sheet, and the non-aqueous waterproof agent can be selected according to practical application requirements of the sheet.

In a preferred embodiment of the present invention, the fiber is selected from one or more of group consisting of wood fiber, paper fiber, hemp fiber, carbon fiber, glass fiber, PP fiber, and polyester fiber.

By adopting the technical solution, due to the excellent extensibility of fiber, the tensile property of the sheet is increased, and the stability and load bearing of the sheet are improved.

In a preferred embodiment of the present invention, the antibacterial agent is selected from one or more of the group consisting of a titanium-based antibacterial agent, chitosan and a silver ion-based antibacterial agent.

By adopting the technical solution, the antibacterial agent is used to improve the corrosion resistance of the sheet, so that the sheet has a prolonged service life.

In a preferred embodiment of the present invention, the flame retardant is selected from one or more of the group consisting of a halogen-based flame retardant, a phosphorus-based flame retardant, magnesium hydroxide and aluminum hydroxide.

By adopting the above technical solution, the flame retardant is used to reduce the possibility of combustion of the sheet, thereby reducing the possibility of occurrence of safety accidents.

In a preferred embodiment of the present invention, the thickener is selected from one or more of the group consisting of carboxymethyl cellulose and carboxyethyl cellulose.

By adopting the above technical solution, the thickener is used to improve the solution stability in the preparation process of the sheet, and adjust the solution viscosity, thereby facilitating formation of the sheet.

In a second aspect, a preparation method of the environment-friendly sheet includes the following steps of:

S1. weighing and adding polyvinyl alcohol into water at 50° C.-95° C., performing stirring until polyvinyl alcohol is completely dissolved, and cooling to room temperature to obtain a first-stage mixture;

S2. weighing and adding fiber, porous hollow microspheres, mineral powder, an antibacterial agent, a humectant, a pigment, a flame retardant and a thickener into the first-stage mixture of S1, and performing stirring to obtain a second-stage mixture;

S3. calendering the second-stage mixture obtained in S2 into a sheet with a thickness of 0.5-130 mm;

S4. drying the sheet prepared in S3 at a temperature of 50° C.-95° C.;

S5. applying the waterproof agent to a surface of the sheet dried in S4; and

S6. drying the sheet prepared in S5 at a temperature of 50° C.-95° C. to obtain the environment-friendly sheet.

By adopting the above technical solution, stirring at an elevated temperature accelerates the dissolution of polyvinyl alcohol; the thickness of the sheet in a range of 0.5-130 mm can meet the requirements on product thickness of different companies, so that the sheet is applicable in a wide range; and the waterproof agent applied to the surface of the sheet can effectively improve the waterproof performance of the sheet, so that the prepared sheet can meet the quality requirements of a user.

In a third aspect, a preparation method of the environment-friendly sheet includes the following steps of:

S1. weighing and adding polyvinyl alcohol power into water containing the aqueous waterproof agent at 50° C.-95° C., performing stirring until polyvinyl alcohol is completely dissolved, and cooling to room temperature to obtain a first-stage mixture;

S2. weighing and adding fiber, porous hollow microspheres, mineral powder, an antibacterial agent, a humectant, a pigment, a flame retardant and a thickener into the first-stage mixture of S1, and performing stirring to obtain a second-stage mixture;

S3. calendering the second-stage mixture obtained in S2 into a sheet with a thickness of 0.5-130 mm; and

S4. drying the sheet prepared in S3 at a temperature of 50° C.-95° C. to obtain the environment-friendly sheet.

By adopting the above technical solution, the aqueous waterproof agent is directly added into water, and then mixed with other components, so that the prepared sheet has good waterproof performance; and the thickness of the sheet in a range of 0.5-130 mm can meet the requirements on product thickness of different companies, so that the sheet is applicable in a wide range.

In summary, the present application has at least one of the following beneficial effects.

1. Fiber and mineral powder can improve the tensile property and load bearing of the sheet and also allow the sheet to have a light weight;

2. All the components used herein are degradable with low toxicity or no toxicity, so that the sheet is environment-friendly and degradable, and causes little pollution to environment;

3. With the waterproof agent and the antibacterial agent, the waterproof and antibacterial performance of the sheet are effectively improved, so that the sheet has a prolonged practical life;

4. The flammability of the sheet can be reduced with the flame retardant, thereby reducing the possibility of occurrence of safety accidents;

5. The environment-friendly sheet disclosed herein is appliable in a wide range, and can be bonded to the back surfaces of various floorings, such as PVC floorings, PP decorative layers, polyurethane decorative layers, wood-plastic floorings, solid wood floorings, solid wood composite floorings, MGO floorings, composite wood floorings with MGO as substrates, stone floorings with MGO as substrates and the like, to provide a function of sound insulation;

6. The environment-friendly sheet disclosed herein is appliable in a wide range and can be used as a floor decorative material, and decorative surface layers, such as PVC decorative surfaces, PP decorative surfaces, polyurethane decorative layers, melamine decorative surfaces, solid wood decorative surfaces, stone decorative surfaces, soft porcelain decorative surfaces and ceramic decorative surfaces, can be bonded to one surface or both surfaces of the sheet with an adhesive, and mortises can be formed in side edges of the sheet;

7. The environment-friendly sheet disclosed herein is appliable in a wide range and can be used as a wall decorative material or a ceiling decorative material, and decorative surface layers, such as PVC decorative surfaces, PP decorative surfaces, polyurethane decorative layers, melamine decorative surfaces, solid wood decorative surfaces, stone decorative surfaces, enamel decorative surfaces and soft porcelain decorative surfaces, can be bonded to one surface or both surfaces of the sheet, and mortises can be formed in side edges of the sheet; and

8. The environment-friendly sheet disclosed herein is appliable in a wide range, and can be used as a printing decorative material with patterns printed on the surface of the sheet; can be used as a packaging material for preparing packaging boxes; and can be used as a liner or filler material to be used as a filler or liner, such as a bag liner and the like.

### DETAILED DESCRIPTION OF THE INVENTION

### Example 1

An environment-friendly sheet was prepared from the following components in parts by weight: 20 parts of polyvinyl alcohol; 30 parts of water; 0.5 part of polyurethane; 8 parts of carbon fiber; 1 part of porous hollow microspheres; 0.1 part of clay; 2 parts of chitosan; 2 parts of a humectant; 2 parts of a PP pigment; 1 part of aluminum hydroxide; and 2 parts of carboxymethyl cellulose.

The environment-friendly sheet in this example was prepared by the following steps:

S1. polyvinyl alcohol powder was weighed and added into water of 60° C., which was stirred until polyvinyl alcohol was completely dissolved, and the temperature was cooled to room temperature to obtain a first-stage mixture;

S2. the carbon fiber, the porous hollow microspheres, the clay, the chitosan, the humectant, the PP pigment, the aluminum hydroxide and the carboxymethyl cellulose were weighed and added into the first-stage mixture of S1, and stirring was performed to obtain a second-stage mixture;

S3. the second-stage mixture obtained in S2 was calendered into a sheet with a thickness of 30 mm;

S4. the sheet prepared in S3 was dried at a temperature of 50° C.;

S5. the polyurethane in an amount according to the formula was applied to a surface of the sheet dried in S4; and

S6. the sheet prepared in S5 was dried at a temperature of 50° C. and trimmed into a desired size to obtain the environment-friendly sheet.

### Example 2

An environment-friendly sheet was prepared from the following components in parts by weight: 30 parts of polyvinyl alcohol; 45 parts of water; 1 part of polyurethane; 15 parts of carbon fiber; 3 parts of porous hollow microspheres; 10 parts of clay; 1.5 parts of chitosan; 1.5 parts of a humectant; 1.6 parts of a PP pigment; 3 parts of aluminum hydroxide; and 1.6 parts of carboxymethyl cellulose.

The environment-friendly sheet in this example was prepared by the following steps:

S1. polyvinyl alcohol powder was weighed and added into water of 80° C., stirring was performed until polyvinyl alcohol was completely dissolved, and the temperature was cooled to room temperature to obtain a first-stage mixture;

S2. the carbon fiber, the porous hollow microspheres, the clay, the chitosan, the humectant, the PP pigment, the aluminum hydroxide and carboxymethyl cellulose were weighed and added into the first-stage mixture of S1, and stirring was performed to obtain a second-stage mixture;

S3. the second-stage mixture obtained in S2 was calendered into a sheet with a thickness of 30 mm;

S4. the sheet prepared in S3 was dried at a temperature of 70° C.;

S5. the polyurethane in an amount according to the formula was applied to a surface of the sheet dried in S4; and

S6. the sheet prepared in S5 was dried at a temperature of 70° C. and trimmed into a desired size to obtain the environment-friendly sheet.

### Example 3

An environment-friendly sheet was prepared from the following components in parts by weight: 40 parts of polyvinyl alcohol; 55 parts of water; 2 parts of polyurethane; 20 parts of carbon fiber; 7 parts of porous hollow microspheres; 20 parts of clay; 1 part of chitosan; 1 part of a humectant; 0.8 part of a PP pigment; 6 parts of aluminum hydroxide; and 0.9 part of carboxymethyl cellulose.

The environment-friendly sheet in this example was prepared by the following steps:

S1. polyvinyl alcohol powder was weighed and added into water of 95° C., stirring was performed until polyvinyl alcohol was completely dissolved, and the temperature was cooled to room temperature to obtain a first-stage mixture;

S2. the carbon fiber, the porous hollow microspheres, the clay, the chitosan, the humectant, the PP pigment, the aluminum hydroxide and the carboxymethyl cellulose were weighed and added into the first-stage mixture of S1, and stirring was performed to obtain a second-stage mixture;

S3. the second-stage mixture obtained in S2 was calendered into a sheet with a thickness of 30 mm;

S4. the sheet prepared in S3 was dried at a temperature of 90° C.;

S5. the polyurethane in an amount according to the formula was applied to a surface of the sheet dried in S4; and

S6. the sheet prepared in S5 was dried at a temperature of 90° C. and trimmed into a desired size to obtain the environment-friendly sheet.

### Example 4

An environment-friendly sheet was prepared from the following components in parts by weight: 50 parts of polyvinyl alcohol; 60 parts of water; 0.8 part of polyurethane; 1 part of carbon fiber; 5 parts of porous hollow microspheres; 30 parts of clay; 0.1 part of chitosan; 0.5 part of a humectant; 0.1 part of a PP pigment; 10 parts of aluminum hydroxide; and 0.5 part of carboxymethyl cellulose.

The environment-friendly sheet in this example was prepared by the following steps:

S1. polyvinyl alcohol powder was weighed and added into water of 95° C., stirring was performed until polyvinyl alcohol was completely dissolved, and the temperature was cooled to room temperature to obtain a first-stage mixture;

S2. the carbon fiber, the porous hollow microspheres, the clay, the chitosan, the humectant, the PP pigment, the aluminum hydroxide and the carboxymethyl cellulose were weighed and added into the first-stage mixture of S1, and stirring was performed to obtain a second-stage mixture;

S3. the second-stage mixture obtained in S2 was calendered into a sheet with a thickness of 30 mm;

S4. the sheet prepared in S3 was dried at a temperature of 170° C.;

S5. polyurethane in an amount according to the formula was applied to a surface of the sheet dried in S4; and

S6. the sheet prepared in S5 was dried at a temperature of 170° C. and trimmed into a desired size to obtain the environment-friendly sheet.

### Example 5

An environment-friendly sheet was prepared from the following components in parts by weight: 40 parts of polyvinyl alcohol; 55 parts of water; 2 parts of an aqueous waterproof agent; 8 parts of carbon fiber; 7 parts of porous hollow microspheres; 20 parts of clay; 1 part of chitosan; 1 part of a humectant; 0.8 part of a PP pigment; 6 parts of aluminum hydroxide; and 0.9 part of carboxymethyl cellulose.

The environment-friendly sheet in this example was prepared by the following steps:

S1. polyvinyl alcohol power was weighed and added into water containing sodium methyl silicate at 50° C.-95° C., stirring was performed until polyvinyl alcohol was completely dissolved, and the temperature was cooled to room temperature to obtain a first-stage mixture;

S2. the carbon fiber, the porous hollow microspheres, the clay, the chitosan, the humectant, the PP pigment, the aluminum hydroxide and the carboxymethyl cellulose were weighed and added into the first-stage mixture of S1, and stirring was performed to obtain a second-stage mixture;

S3. the second-stage mixture obtained in S2 was calendered into a sheet with a thickness of 30 mm; and

S4. the sheet prepared in S3 was dried at a temperature of 95° C. and trimmed into a desired size to obtain the environment-friendly sheet.

In Examples 1 to 5: the polyvinyl alcohol was purchased from Shanghai Aladdin Bio-Chem Technology Co., Ltd.; the aqueous waterproof reagent was sodium methyl silicate purchased from Wuhan Carnoss Technology Co., Ltd.; the polyurethane was purchased from Liaoning Qingyang Chemical Industry Corporation; the carbon fiber was purchased from Forsman Scientific (Beijing) Co., Ltd., with a length of 25 mm and a diameter of 10 um; porous hollow microspheres were porous hollow silica microspheres purchased from Beijing Zhongkeleiming Technology Co. Ltd.; the clay was purchased from Sigma-Aldrich (Shanghai) Trading Co., Ltd.; chitosan was purchased from Sigma-Aldrich (Shanghai) Trading Co., Ltd.; the humectant was glycerin purchased from Taishan Changshun Glycerin Products Co., Ltd.; the PP pigment was purchased from Yuhong Pigment Co., Ltd.; the aluminum hydroxide was purchased from Shanghai Aladdin Bio-Chem Technology Co., Ltd.; and the carboxymethyl cellulose was purchased from Shanghai Aladdin Bio-Chem Technology Co., Ltd.

In order to better illustrate the effect of the invention, materials commonly used for silence layers in the market were selected as comparative examples and specifically described as follows:

### Comparative Example 1

A polyvinyl alcohol film with a degradation rate of 90% purchased from Changzhou Green Cradleland Macromolecule Materials Co., Ltd.

### Comparative Example 2

A PE foam film purchased from Wuhan Kitty Plastic Products Co., Ltd.

### Comparative Example 3

Differing from Example 3 in that: no fiber was added in Comparative Example 3.

### Comparative Example 4

Differing from Example 3 in that: no clay was added in Comparative Example 4.

Degradation tests were carried out on the environment-friendly sheets prepared in Examples 1 to 5, as well as the polyvinyl alcohol film in Comparative Example 1 and the PE foam film in Comparative Example 2, as follow:

Test 1: Acid Degradation Test

Each of the sheets was weighed and then immersed in 0.1 mol/L hydrochloric acid, the sheet was left to stand at room temperature for 60 days and taken out, residual hydrochloric acid on the surface of the sheet was removed, and the sheet was weighed again; and the degradation rate of each sheet was calculated according to the following formula, and recorded:

Degradation rate=(initial sheet weight−final sheet weight)/final sheet weight*100%

where the unit for the sheet weight is g.

Test 2: Alkaline Degradation Test

Each of the sheets was weighed and then immersed in 0.1 mol/L sodium hydroxide, the sheet was left to stand at room temperature for 60 days and taken out, residual hydrochloric acid on the surface of the sheet was removed, and the sheet was weighed again; and the degradation rate of each sheet was calculated according to the following formula, and recorded:

Degradation rate=(initial sheet weight−final sheet weight)/final sheet weight*100%

where the unit for the sheet weight is g.

Test 3: Oxidative Degradation Test

Each of the sheets was weighed and then immersed in hydrogen peroxide with a content of 30%, the sheet was left to stand at room temperature for 60 days and taken out, residual hydrochloric acid on the surface of the sheet was removed, and the sheet was weighed again; and the degradation rate of each sheet was calculated according to the following formula, and recorded:

Degradation rate=(initial sheet weight−final sheet weight)/final sheet weight*100%

where the unit for the sheet weight is g.

The results of Tests 1 to 3 are shown in Table 1.

TABLE 1

| | | | | | | Com- | Com- |
|---|---|---|---|---|---|---|---|
| | | | | | | par- | par- |
| | | | | | | ative | ative |
| | Exam- | Exam- | Exam- | Exam- | Exam- | Exam- | Exam- |
| Items | ple 1 | ple 2 | ple 3 | ple 4 | ple 5 | ple 1 | ple 2 |
| Degra- | 94% | 95% | 97% | 96% | 97% | 90% | 76% |
| dation | | | | | | | |
| rate | | | | | | | |
| (acid | | | | | | | |
| degra- | | | | | | | |
| dation | | | | | | | |
| test) | | | | | | | |
| Degra- | 93% | 94% | 96% | 95% | 96% | 89% | 73% |
| dation | | | | | | | |
| rate | | | | | | | |
| (alkaline | | | | | | | |
| degra- | | | | | | | |
| dation | | | | | | | |
| test) | | | | | | | |
| Degra- | 94% | 95% | 97% | 96% | 97% | 88% | 71% |
| dation | | | | | | | |
| rate | | | | | | | |
| (oxi- | | | | | | | |
| dative | | | | | | | |
| degra- | | | | | | | |
| dation | | | | | | | |
| test) | | | | | | | |

As can be seen from Table 1, as compared with Comparative Example 1 and Comparative Example 2, the degradation rates of the sheets in Examples 1 to 5 are all larger than those of Comparative Example 1 and Comparative Example 2 and close to that of Comparative Example 1, indicating that the environment-friendly sheet disclosed by the present invention has good degradation performance and little influence on the environment.

Test 4: Sound Insulation Performance Test

The sound insulation performance of the environment-friendly sheet was tested according to the standard No. ASTME2179 (Standard Test Method for Laboratory Measurement of the Effectiveness of Floor Coverings in Reducing Impact Sound Transmission Through Concrete Floors), and the results are shown in Table 2.

TABLE 2

| | | | | | | Com- | Com- |
|---|---|---|---|---|---|---|---|
| | | | | | | par- | par- |
| | Exam- | Exam- | Exam- | Exam- | Exam- | ative | ative |
| | ple | ple | ple | ple | ple | Exam- | Exam- |
| Item | 1 | 2 | 3 | 4 | 5 | ple 1 | ple 2 |
| Sound | 30 | 31 | 32 | 31 | 32 | 20 | 22 |
| trans- | | | | | | | |
| mission | | | | | | | |
| loss | | | | | | | |
| (dB) | | | | | | | |

As can be seen from Table 2, as compared with Comparative Example 1 and Comparative Example 2, the sound transmission losses of the sheets in Examples 1 to 5 are all larger than those of Comparative Example 1 and Comparative Example 2, indicating that the environment-friendly sheet disclosed by the present invention has good sound insulation performance.

Test 5: Waterproof Performance Test Using an Electric Linoleum Impervious Instrument

(1) when there was no pressure of an air pump in a system, a water drain valve 8 was closed, water permeable disc stop valves 9, 10 and 11 were closed, a water inlet valve 6 and an air discharge valve 7 were opened, and water was added into an air-liquid actuator to a position 50 mm away from the top of air-liquid actuator;

(2) a pressure reducing valve was adjusted to make the air pressure to reach a pressure required by the test, each of the water permeable disc stop valves 9, 10 and 11 was slowly unscrewed to fill a water impermeable disc with water slowly and then the stop valves were closed, a sample was placed onto the water impermeable disc and fixed to the water permeable disc with a gland, and the gland was compressed with bolts;

(3) a power switch was turned on, an alarm switch was turned to an “on” position, a time relay was set to 5 h, and the stop valves 9, 10 and 11 were opened; and

(4) a timing knob switch was set to an “on” position to start timing, an audible signal was sent out when timing was finished, then the timing switch was opened, and the sample was taken out.

Judging standard: if the sample was permeable to water, the electric linoleum impervious instrument would send out an acousto-optic alarm automatically.

In this test, each of the environment-friendly sheets prepared in Examples 1 to 5, as well as the polyvinyl alcohol film in Comparative Example 1 and the PE foam film in Comparative Example 2 was tested for 8 times, the number of times of permeation was recorded and the permeability rate was calculated, wherein Permeability rate=number of times of permeation/8*100%. The test results are shown in Table 3.

TABLE 3

| | | | | | | Com- | Com- |
|---|---|---|---|---|---|---|---|
| | | | | | | par- | par- |
| | Exam- | Exam- | Exam- | Exam- | Exam- | ative | ative |
| | ple | ple | ple | ple | ple | Exam- | Exam- |
| Items | 1 | 2 | 3 | 4 | 5 | ple 1 | ple 2 |
| Number | 1 | 0 | 0 | 0 | 0 | 3 | 4 |
| of times | | | | | | | |
| of | | | | | | | |
| perme- | | | | | | | |
| ation | | | | | | | |
| Perme- | 12.5% | 0 | 0 | 0 | 0 | 37.5% | 50% |
| ability | | | | | | | |
| rate | | | | | | | |

As can be seen from Table 3, the permeability rates of the sheets in Examples 1 to 5 are significantly lower than those of Comparative Example 1 and Comparative Example 2, indicating that the waterproof performance of the sheet can be effectively improved by using polyurethane or sodium methyl silicate as the waterproof agent in the present invention.

Test 6: Tensile Property Test

The sheet in Example 3, the polyvinyl alcohol film in Comparative Example 2, and the sheets in Comparative Example 3 and Comparative Example 4 were made to have a thickness of 0.5 mm, a length of 80 mm, and a width of 10 mm; then, according to the standard No. GB13022-91 (Determination of Tensile Properties of Plastics), a strain value corresponding to a yield point in the stress-strain curve, i.e. the elongation value, was found, and the tensile property of each sample was determined accordingly. The test results are shown in Table 4.

TABLE 4

| | Comparative | Comparative | Comparative | |
|---|---|---|---|---|
| Items | Example 2 | Example 3 | Example 4 | Example 3 |
| L | 269.4 | 285.4 | 293.7 | 304.5 |
| L₀ | 80 | 80 | 80 | 80 |
| Elongation | 2.37 | 2.57 | 2.67 | 2.81 |

In Table 4: Elongation=(L−L₀)/L₀*100%, in the formula, L₀ is the initial length of each sample, and L is the elongation corresponding to the yield point.

As can be seen from Table 4, as compared with Comparative Example 2, the elongations of the sheets in Comparative Example 3, Comparative Example 4 and Example 3 are all larger than that of Comparative Example 2, indicating that the environment-friendly sheet disclosed by the present invention has a good tensile property. As compared with Comparative Example 3 and Comparative Example 4, the elongation of Example 3 is larger than those of both Comparative Example 3 and Comparative Example 4, indicating that carbon fiber and clay added in the environment-friendly sheet disclosed by the present invention can effectively improve the tensile property of the sheet.

The embodiments of the present invention are all preferred embodiments of the invention, and are not intended to limit the scope of the invention. Accordingly, any equivalent variations made based on the shape, structure and principles of present invention are intended to be included within the scope of the present invention.

What is claimed is:

1. An environment-friendly sheet, comprising following components in parts by weight:
20-50 parts of polyvinyl alcohol; 40-60 parts of water; 1-20 parts of fiber; 1-7 parts of porous hollow microspheres; 0.1-30 parts of mineral powder; 0.1-2 parts of an antibacterial agent; 0-2 parts of a humectant; 0-2 parts of a pigment; 0-10 parts of a flame retardant; 0-2 parts of a thickener; and an agent,
wherein the agent is 0.1-5 parts of a waterproof agent.

2. The environment-friendly sheet according to claim 1, wherein the agent is 1-5 parts of an aqueous waterproof agent.

3. The environment-friendly sheet according to claim 1, wherein the agent is 0.1-2 parts of a non-aqueous waterproof agent; and
wherein the non-aqueous waterproof agent is one or more selected from the group consisting of polyurethane, a fatty acid-based waterproof agent, and a stearic acid-based waterproof agent.

4. The environment-friendly sheet according to claim 1, wherein the fiber is one or more selected from the group consisting of wood fiber, paper fiber, hemp fiber, carbon fiber, glass fiber, PP fiber, and polyester fiber.

5. The environment-friendly sheet according to claim 1, wherein the antibacterial agent is one or more selected from the group consisting of a titanium-based antibacterial agent, chitosan, and a silver ion-based antibacterial agent.

6. The environment-friendly sheet according to claim 1, wherein the flame retardant is one or more selected from the group consisting of a halogen-based flame retardant, a phosphorus-based flame retardant, magnesium hydroxide, and aluminum hydroxide.

7. The environment-friendly sheet according to claim 1, wherein the thickener is one or more selected from the group consisting of carboxymethyl cellulose, and carboxyethyl cellulose.

8. A preparation method of the environment-friendly sheet according to claim 1, comprising the following steps of:
S1: weighing and adding polyvinyl alcohol into water of 50° C.-95° C., performing stirring until the polyvinyl alcohol is completely dissolved, and cooling to room temperature to obtain a first-stage mixture;
S2: weighing and adding fiber, porous hollow microspheres, mineral powder, an antibacterial agent, a humectant, a pigment, a flame retardant, and a thickener into the first-stage mixture of S1, and performing stirring to obtain a second-stage mixture;
S3: calendering the second-stage mixture obtained in S2 into a sheet with a thickness of 0.5-130 mm;
S4: drying the sheet prepared in S3 at a temperature of 50° C.-95° C.;
S5: applying a waterproof agent to a surface of the sheet dried in S4; and
S6: drying the sheet prepared in S5 at a temperature of 50° C.-95° C. to obtain the environment-friendly sheet.

9. A preparation method of the environment-friendly sheet according to claim 1, comprising the following steps of:
S1: weighing and adding polyvinyl alcohol power into water containing an aqueous waterproof agent of 50° C.-95° C., performing stirring until the polyvinyl alcohol is completely dissolved, and cooling to room temperature to obtain a first-stage mixture;
S2: weighing and adding fiber, porous hollow microspheres, mineral powder, an antibacterial agent, a humectant, a pigment, a flame retardant and a thickener into the first-stage mixture of S1, and performing stirring to obtain a second-stage mixture;
S3: calendering the second-stage mixture obtained in S2 into a sheet with a thickness of 0.5-130 mm; and
S4: drying the sheet prepared in S3 at a temperature of 50° C.-95° C. to obtain the environment-friendly sheet.
